(19) United States
(12) Patent Application Publication
(10) Pub. No.: US 2012/0030108 A1
(43) Pub. Date: Feb. 2, 2012

(54) SYSTEM AND METHOD FOR THE REMOTE IDENTIFICATION AND VERIFICATION OF A CLIENT'S IDENTITY DURING THE PROVISION OF FINANCIAL SERVICES

(76) Inventor: Natalia Petrovna Katina, Moscow (RU)

(21) Appl. No.: 13/128,011

(22) PCT Filed: Jul. 21, 2009
(86) PCT No.: PCT/RU2009/000363

§ 371 Date: Oct. 20, 2011

(30) Foreign Application Priority Data
Nov. 6, 2008 (RU) 2008-143645

(51) Int. Cl. G06Q 40/02; G06Q 20/40

(52) U.S. Cl. 705/43; 705/44

(57) ABSTRACT

The invention relates to financial services, in particular involving the use of automatic terminals and/or cash dispensers, in order to remotely identify and verify a person's identity during the provision of services to an individual. The system for the remote identification and verification of a client's identity during the provision of financial services comprises the following components linked by the Internet or by other communications channels: a processing center server and at least one remote client terminal with a service request interface, which terminal is provided with a multifunctional scanning device and devices for exchanging visual and audio information. At least one computerized operator workstation, which is also provided with devices for exchanging visual and audio information, is linked to the above-mentioned terminal via the processing center; furthermore, the operator working interface of the processing center server comprises the following, arranged in series: an identification module consisting of automatic and subjective units, a verification module also consisting of automatic and subjective units, a client database, in the cells of which information about personal identity identification and verification operations carried out on the operator working interface is recorded and stored and which, in response to an incoming request, generates reports about contacts that have taken place, and referral databases and/or prohibitive databases which are connected to an automatic identification module for recognizing/reading and checking the validity of the identity papers produced by the client. Furthermore, the client is identified without preliminary registration of the client and only according to an electronic copy, received from the request terminal, of at least one identity paper belonging to the client, using subjective identification, and the client's identity is verified during an audio-visual communication session between the selected operator and the client, who are remote from each other, in a real-time mode during the entire operation carried out via the processing center server.

The invention is concerned with financial services technology, in particularly for remote client's personal identification and verification through automatic terminals and/or ATM services to individual persons.

There is a well-known and practically used system and method of personal identification and verification of a client at a POS where the operational staff checks the personal identification document (ID) of the client's, for example passport (identification procedure), and ensures the client is the identification document owner (verification procedure). The client must be physically presence at the POS for identification and verification during business hours.

The main disadvantage of this system and method is the impossible for remote implementation with the usage of the modern technologies and retention of determinative human control of reliability and accuracy of the result of identification and verification.

There is also a known automatic system and method for clients' identification that can be used for the financial services. The identification process involves using a unique identification number and/or client's personal card; and/or correctly state the previously agreed test answer; and/or by biometric methods. For example, there is a system of biometric identification in the international application WO2007022423 (GO7F 7/10, published 22.02.2007)

Also known have been an automated system for performing financial payments according to a utility model patent RU57921 (GO6F 12/00, published 27.10.2006) which comprises a user identification unit using a codogram being entered by the user. The disadvantage of this solution is that it does not provide personality verification and requires the client to preregister at a bank branch and the client's information and image is stored at the bank's system.

Solutions comprising a client verification step have been known.

For example, known has been a system for receiving payments and forming and controlling documents of payment according to a utility model patent RU74510 (GO9F 11/02, publ. 27.06.2008), in which a process of payment at a POS can be controlled from a bank server. The system comprises a mobile phone, a sensor display and a web camera performing photographing for visual client identification connected to a mini-terminal connected to a bank server. The client identification is carried out using according to a mobile phone number entered into an agreement with the bank. The photo of the client is transmitted to the bank to be stored in the server, and the display shows an animated image of the bank teller serving a visual helper in performing the payment. However, conducting payments requires a mandatory visit of a client to the bank to be registered with the bank that keeps document copies and client's photo for further comparison. Unlike the known method, the one proposed in this application provides that any person with no pre-registration can perform the operation. Beside that, according to international standards adopted by internationally acclaimed organizations FATF and OFAC, a photo cannot be used for person's verification for financial transactions. The animation of the teller's image is used for prompting in conducting transactions, and there is no interaction between the client and teller. Accordingly, a verification of the photo being a person's photo rather than a photo made using a person's photo cannot be obtained.

There is a known system for, and a method of, transmitting an image for further comparison with the image stored in a database according to the International application WO2008018032 (H04M 1/66, published 14.02.2008) where a telecommunication device can include a mobile phone whose number and PIN, rather than the client, are used for verification to confirm that the image was transmitted from the very registered device.

Known from U.S. application 2007/0295805 (GO7F 19/00, published 27.12.2007) is a system for obtaining cash from an automatic terminal via videophone. A client makes a request to the bank server from his personal mobile phone. The client requests the amount to be withdrawn and confirms the identification code of the automatic terminal The client is neither identified nor verified. Rather, only the mobile phone and automatic terminal are identified in the transaction. Downloading a program provided by the client's bank onto the client's mobile phone enables the client to get cash through the automatic terminal. This method serves an alternative to widely used debit cards giving clients access to their accounts via automatic teller machines (ATM).

Applicant believes that a system for transferring funds disclosed in RU74231 (G06Q 200/00, published 20.06.2008) is the closest analog to the present invention. The system comprises a system server with control functions, to which a sensor display, a fingerprint sensor, a cellular phone module, and an optical 3D scanner are connected. The display provides interaction with a client, the fingerprint sensor is used for client's identification at the server, and the module serves to send notification SMS messages, whereas the scanner is used for 3D scanning the client's face to visually identify the client. The disadvantage of this solution is that the client has to visit the bank for registering and providing a 3D image to be used for further comparison. Beside that, the system does not perform transferring funds, the client instructing the bank instead to remit money from his account. Additionally, the 3D scanner, provided such a scanner exists, is supposed to be a complicated and expensive unit, currently not expected to be in quantity production.

Applicant is not aware of methods of remote automated verification of client's identity that can be used upon rendering financial services. The automated verification methods discussed above cannot be used for automated verification because the owner can pass the information and/or information carrier on to third persons, and/or they can obtain the same illegally.

The absence of automated methods of remote identity verification results in that the number of types of financial services available by using ATM or automatic terminals or other remote terminals is limited as compared with those available at points of service, inasmuch as the possibility of providing a great number of financial services is conditioned, in compliance with adopted international procedures, by a mandatory identification and verification of client's identity.

The main peculiarity of the method according to the present invention is providing an operator remote from the client access terminal with the ability to perform client identification and verification. It creates a possibility for providing a full range of financial services not only at the points of service but also via automatic terminals and/or ATM, etc.

None of known prior art solutions makes it possible to achieve the above stated technical result. Unlike the known methods, the present one offers the following advantages:
It provides a double verification of IDs submitted by a client. The automatic verification is performed by a set of programs approved and/or certified by competent authorities, whereas the subjective verification is conducted by a remote operator.
It provides a double verification of the correspondence of the client's identity to the submitted IDs. A set of programs approved and/or certified by competent authorities performs a check of the correspondence of biometric parameters of the appearance of the person submitting an ID to the appearance of the person shown on the ID, whereas the subjective verification is conducted by a remote operator.
It makes it possible to provide full and detailed reports on all clients asking for services. At the request of national and international monitoring agencies, financial institutions are obliged to report the transactions requested about, as well as repeated and suspicious transactions. The method of the present invention provides a means of submitting both a documented and an audio-visual report for every client.
It allows the size of network providing services to be augmented to include both financial companies' points of service and their ATM and automatic terminals.
It allows engaging non-financial retail companies having automatic terminals in providing financial services.
It allows changing the quality of the service making it more accessible and convenient for the clients since ATM and automatic terminals are available 24 hours a day, 356 days a year.
It allows introducing multilingual service for the clients, which makes the service more accessible while increasing the reliability of data verification.

In this way, the technical result that the present invention pursues is enhancing the reliability of the procedure of providing financial services while augmenting functional possibilities in rendering same.

Hence, the present invention touches upon the interests of the financial institutions, as well as clients. It allows the financial institutions to make performing some of the services automated that has effect on prime cost and competitive advantage, contributes to the growth of financial services, and appeals to bettering the quality of service by augmenting the service network quantitatively and qualitatively and making it possible for clients to use the services at any convenient time.

The above stated technical result is achieved by providing remotely the client identification and client's identity verification, which precede rendering the financial service and are carried out by means of the following units interconnected via Internet and/or other channels:
An operational center or a network of interconnected operational centers in various countries (for clients' convenience and the possibility of communicating in the national language) whose operators being outside an access terminal and a processing center, successively authorize in real time the identification and verification of a client upon a coming service request. The remote operational center comprises at least one operator and a corresponding operator automatic workstation (AWS) having access via an operator interface to a processing center server, as well as a visual intercommunication unit and an audio intercommunication unit which allow for establishing a two-way audio-visual communication channel between the operator and client remote from each other.
At least one client access terminal that can, for instance, include an ATM and/or automated terminal that the client can use for an independent service request. Beside conventional units, the terminal additionally comprises a client interface, which is to be filled in by the client and from which the request is transmitted to the processing center; multi-purpose scanner used particularly for scanning IDs; a visual intercommunication unit and an audio intercommunication unit which allow for establishing a two-way audio-visual communication channel between the client and operator remote from each other.
The processing center comprising at least one server and a set of application programs intended to provide a procedure of identification and verification of the service requesting client identity, through which the client access terminal and operational center communicate with each other, and a report is generated upon a request.

The processing center comprises:
an operator selection module to analyze the service request coming from the access terminal client interface and to address the particular competent operator to be selected according to the dialog language chosen, the service requested, and the operator occupancy condition judgment;
an automatic identification module (AIM), which is responsible for checking the consistency between the IDs submitted by the client and the requirements and its authenticity and for recognizing and reading the document, comprising a set of application programs that can vary depending on the requirements of national legislation and required regional licensing to comply with, which is connected to an inquiry and a restraining databases;
an automatic verification module (AVM), which, in response to a service request, is responsible for checking the consistency between client's biometric parameters and the client's photo on the ID submitted, comprising a set of application programs that can vary depending on the requirements of national legislation and required regional licensing to comply with;
an operator interface accessible for the operator from a remote AWS. It is through this interface that the operator at the operational center has audio-visual communication with the client located next to the access terminal. The operator interface successively displays an identification module (CIM) comprising an assessment of the AIM and a subjective identification module (SIM) providing the operator with the fields to be filled in, then a verification module (CVM) comprising an assessment of the AVM and a subjective verification module (SVM) providing the operator with the fields to be filled in. The operator can successively either deny authorization or authorize the identification and verification procedures or authorize adding a note that the client in question instills suspicions.
a client database, which collects and saves information about identification and verification procedures under way. The database comprises individual information about each client served—the day and time of the service request, the service requested, client's identity data, assessment of the AIM, assessment of the SIM, assessment of the AVM, assessment of the SVM; a record of a operator-client audio-video session;
a program module generating records at a request in accordance with the following parameters or aggregation of parameters—according to geography of client access terminal locations, or data of clients requested service, or date and time of a transaction, or clients failed in the identification procedure, or clients failed in the verification procedure;
a reference database of identification documents or a set of databases, restraining ones including, which are used for checking authenticity of documents and uncovering cases of fraud, for example a database of lost and cancelled passports. Having such databases and their content depend on peculiarities of local market legislation hinging on obtaining information from the authorities and also depend on the requirements of international competent bodies. The reference databases are connected to the AIM, which assesses IDs based on reference database criteria and results of checking the restraining database.

The method of remote client's personal identification and verification when rendering financial services involves the following process:

The client initiates request for financial service from the remote access terminal and is offered to full in fields provided by the client interface. Depending on the dialog language and service selected by the client, the processing center automatically direct the client's request to an available operator that suits the parameters shown. From a remote AWS, the operator enters the operator interface in the processing center. From that moment and till the stage of authorization or denial the same with regard to the successive identification and verification of client's identity, the processing center supports in real time the audio-video operator-client session, which is recorded in the database of clients. At the request of the access terminal client interface, the client submits the IDs for scanning. The operator successively fills in the SIM and, provided the client's identification is authorized, the SVM in the operator interface. The CIM displays the assessment of an AIM comparison unit, a copy of the client's document submitted, the audio-video session with the client, and the SIM. The client's identity identification authorization is completed by the operator who can authorize even if the assessment of the AIM was negative. In case the operator denies the client's identity identification authorization, information of the denial in rendering the service is displayed in the access terminal client interface, the audio-video operator-client session comes to an end, the content of the CIM and the audio-video operator-client session are logged and kept in the database of clients. The CVM displays the assessment of an AVM comparison unit, a photo of the client from the client's document submitted, the audio-video session with the client, and the SVM. The client's identity verification authorization is completed by the operator who can authorize even if the assessment of the AVM was negative. In case the operator denies the client's identity verification authorization, information of the denial in rendering the service is displayed in the access terminal client interface, the audio-video operator-client session comes to an end, the content of the CIM, CVM, and the audio-video operator-client session are logged and kept in the database of clients. In case of the client's identity authorization after going successively through the CIM and CVM, a program application starts in the operator interface and a module of the financial service selected by the client is displayed, the audio-video operator-client session continuing.

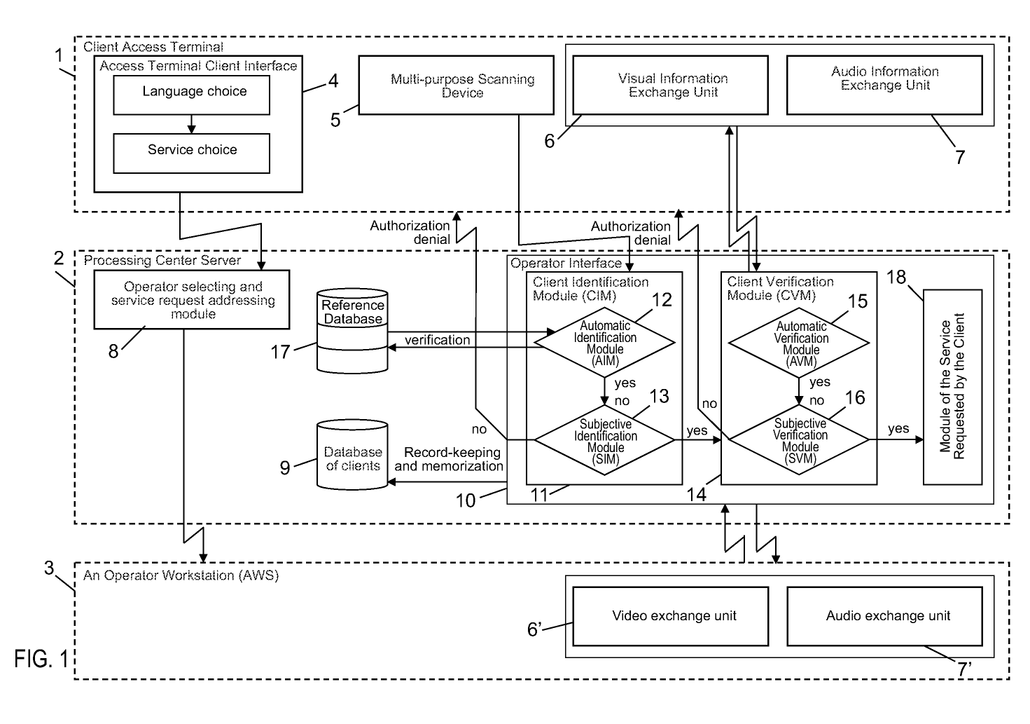

The system and method of remote personal identification and verification of a client according to the present invention are illustrated in FIG. 1.

Where 1 is a client access terminal comprising: 4—an access terminal client interface; 5—a multi-purpose scanning device that can not only, for example, copy but also read the text being scanned; 6—a visual information exchange unit; 7—an audio information exchange unit. The units 6 and 7 can include a combined unit such as a web camera with a headset.

Where 2 is a processing center server comprising: 8—an operator selecting and service request addressing module; 9—a database of clients; 10—an operator interface comprising: 11—a client identification module (CIM) with 12—an automatic identification module (AIM) and 13—a subjective identification module (SIM); 14—a client verification module (CVM) with 15—an automatic verification module (AVM) and 16—a subjective verification module (SVM); 17—a reference database; and 18—a module of the service requested by the client; and

Where 3—an operator workstation (AWS) comprising: 6′—a video exchange unit and 7′—an audio exchange unit. The units 6′ and 7′ can include a combined unit such as a web camera with a headset.

1. A system for remote personal identification and verification of a client while rendering financial services thereto, the system comprising:
a processing center server with at least one database and
at least one remote client access terminal with a client interface for rendering a service,
the processing center server and the at least one remote client access terminal being interconnected via Internet or other telecommunication channels,
characterized by that
the remote client access terminal is provided with a multi-purpose scanning unit, a unit of visual information exchange, and a unit of audio information exchange and is connected via the processing center with at least one automated operator workstation (ARM) equipped with units of visual and audio information exchange;
the processing center server comprises an operator interface with
an identification module (CIM) with an automatic identification module (AIM) and a subjective identification module (SIM);
a verification module (CVM) with an automatic verification module (AVM) and a subjective verification module (SVM);
a client database, in which information about operator interface activity for identifying and verifying identity is being logged and saved and which generates reports when requested about contacts that took place; and
reference databases connected to the AIM for recognizing/reading and authenticity checking the identification documents submitted by the client.

2. The system for remote personal identification and verification of a client according to claim 1, characterized by that the client access terminal includes an ATM of a financial institution.

3. The system for remote personal identification and verification of a client according to claim 1, characterized by that the client access terminal includes an automatic terminal of a financial institution.

4. The system for remote personal identification and verification of a client according to claim 1, characterized by that the client access terminal includes an automatic terminal of a non-financial retail institution.

5. A method of remote personal identification and verification of a client upon providing financial services comprising the steps of requesting a financial service from a remote client access terminal and transmitting the request to a processing center to be subjected to an initial procedure of automatic client's identity identification based on the information submitted by the client, characterized by that the client's identity identification is made without client's preliminary registration and is based only on an electronic copy of at least one identification document (ID) of the client received from the client access terminal, with the use of subjective identification, and client's identity verification is performed during an audio-visual communication session between a selected operator and the client remotely located from each other, which is conducted in real time during all the operations running via a server of the processing center, a client automatic identification module (AIM) conducting recognizing and checking the client's identification document with subsequent sending the assessment thereof to a subjective identification module (SIM), with subsequent checking, provided the identification is authorized, by an automatic verification module (AVM) comparing biometric parameters of the client's appearance for their correspondence to a photo on the ID, with subsequent sending the assessment thereof to a subjective verification module (SVM) prior to addressing a financial service module.

6. The method of remote personal identification and verification of a client upon providing financial services according to claim 5, characterized by that the selection of the operator is performed based on the service requested and the language of the session.

7. The method of remote personal identification and verification of a client upon providing financial services according to claim 5, characterized by that all the identification and verification procedures are recorded and saved in the client database.
